(19) United States
(12) Patent Application Publication
(10) Pub. No.: US 2016/0363972 A1
(43) Pub. Date: Dec. 15, 2016

(54) TEMPERATURE CONTROL OF STORAGE ARRAYS WITH ROTATING MEDIA SEEK ADJUSTMENTS

(71) Applicant: HGST Netherlands B.V., Amsterdam (NL)

(72) Inventors: Todd C. McNally, Peyton, CO (US); Jeffrey D. Wilke, Palmer Lake, CO (US); Robert M. Lester, Colorado Springs, CO (US)

(21) Appl. No.: 14/738,568

(22) Filed: Jun. 12, 2015

(51) Int. Cl. G06F 1/20; G05B 15/02; G06F 1/18

(52) U.S. Cl. CPC G06F 1/206; G06F 1/187; G05B 15/02

(57) ABSTRACT

To provide enhanced operation of data storage devices and systems, various systems, apparatuses, methods, and software are provided herein. In a first example, a data storage array is presented. The data storage array includes a plurality of data storage devices positioned in an enclosure, each of the plurality of data storage devices comprising rotating media for storage and retrieval of data. The data storage array includes one or more temperature sensors configured to measure thermal information associated with the data storage array. The data storage array includes a management controller configured to monitor the thermal information and establish adjustments to at least seek operations of the plurality of data storage devices to control a temperature in the enclosure.

### TECHNICAL FIELD

Aspects of the disclosure are related to the field of data storage and data storage device arrays in data storage systems.

### TECHNICAL BACKGROUND

Computer and network systems such as data storage systems, server systems, cloud storage systems, personal computers, and workstations, typically include data storage devices for storing and retrieving data. These data storage devices can include hard disk drives (HDDs), solid state storage drives (SSDs), tape storage devices, optical storage drives, hybrid storage devices that include both rotating and solid state data storage elements, and other mass storage devices.

As computer systems and networks grow in numbers and capability, there is a need for ever increasing storage capacity. Data centers, cloud computing facilities, and other at-scale data processing systems have further increased the need for digital data storage systems capable of transferring and holding immense amounts of data. Data centers can house this large quantity of data storage devices in various rack-mounted and high-density storage configurations.

While densities and workloads for the data storage devices increase, any individual data enclosures can experience higher heat generation and data loss as well as contribute to increased costs for cooling of data center facilities. Some power saving measures have been included in many data storage devices, such as low power operation, idle modes, and other power management schemes. However, these schemes fail to compensate for increased power dissipation during normal operation or periods of increased workloads.

### OVERVIEW

To provide enhanced operation of data storage devices and systems, various systems, apparatuses, methods, and software are provided herein. In a first example, a data storage array is presented. The data storage array includes a plurality of data storage devices positioned in an enclosure, each of the plurality of data storage devices comprising rotating media for storage and retrieval of data. The data storage array includes one or more temperature sensors configured to measure thermal information associated with the data storage array. The data storage array includes a management controller configured to monitor the thermal information and establish adjustments to at least seek operations of the plurality of data storage devices to control a temperature in the enclosure.

In another example, a method of operating a data storage array that includes a plurality of data storage devices positioned in an enclosure is presented. The method includes measuring thermal information associated with the data storage array using one or more thermal sensors to identify at least a temperature in the enclosure, determining adjustments to at least seek operations of the plurality of data storage devices to control the temperature in the enclosure, transferring instructions to one or more of the plurality of data storage devices to implement the adjustments to the seek operations.

In another example, a data storage assembly is presented. The data storage assembly includes a plurality of data storage devices comprising rotating magnetic media for storage and retrieval of data and at least one temperature sensor. The data storage assembly includes an enclosure configured to enclose and structurally support the plurality of data storage devices, the enclosure comprising one or more temperature sensors configured to measure temperature in the enclosure and one or more fans configured to provide airflow to the plurality of data storage devices in the enclosure. The data storage assembly includes a control system configured to monitor the temperature in the enclosure using the one or more temperature sensors and temperature information received from the plurality of data storage devices. The control system is configured to adjust at least one of a plurality of operational factors of the data storage assembly to maintain the temperature in the enclosure below a temperature threshold, the operational factors comprising fan speed of the one or more fans, a just-in-time (JIT) seek performance of the plurality of data storage devices, and background media scan (BMS) integrity checking of the plurality of data storage devices.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a data system.

FIG. 2 is a flow diagram illustrating a method of operation of a data storage system.

FIG. 3 is a system diagram illustrating a data system.

FIG. 4 is a flow diagram illustrating a method of operation of a data storage system.

### DETAILED DESCRIPTION

Data storage devices, such as hard disk drives and hybrid disk drives that have both rotating and solid state storage elements, can be included in various arrayed configurations, such as rack-mounted enclosures which house dozens of individual drives. Cooling or ventilation fans can be included with the enclosures to direct airflow over the various drives. However, heat generation and removal from the enclosures can be difficult to manage, especially when ambient temperatures outside of the enclosures rise which prevent ventilation fans from effectively dropping the temperature of an enclosure.

Heat generation in these drives and enclosures is typically linked to present workloads and associated power dissipation. Some power saving measures have been included in many data storage devices, such as low power operation, idle modes, and other power management schemes. However, these power management schemes typically require the drives to be idle or have presently light workloads, and fail to compensate for increased power dissipation during normal operation or periods of increased workloads.

Drives which incorporate rotating media, such as rotating magnetic media of hard disk drives, among others, also include various electromechanical elements to position read/write heads over the spinning media. These electromechanical elements include armatures, motors, actuators, voicecoils, servos, or other elements which can have associated power dissipation characteristics. Typically, a storage device positions the associated read/write elements over a desired portion of the media as quickly as possible to reduce lag time for reading and writing of data. However, in spinning media, even if the read/write head is positioned to a proper circumferential location, namely a data track, the media might still need to make a portion of a full rotation to place a desired data block under the read/write head. This process of moving the read/write heads to a desired track position is typically referred to as a seek operation.

Just-in-time (JIT) seek techniques have been developed which take advantage of seek delays in positioning of data blocks on the spinning media under the read/write heads. Various tracking algorithms can identify a position of the spinning media relative to a current read/write head position and establish a time to move the read/write heads to a desired position so as to meet the desired data block at a desired time without extra rotational delays incurred after positioning of the read/write head. These JIT techniques typically use less peak power than merely positioning the read/write head as fast as the electromechanical elements allow. Additionally, JIT techniques can include various selectable levels of seek performance, such as 256 levels in some examples.

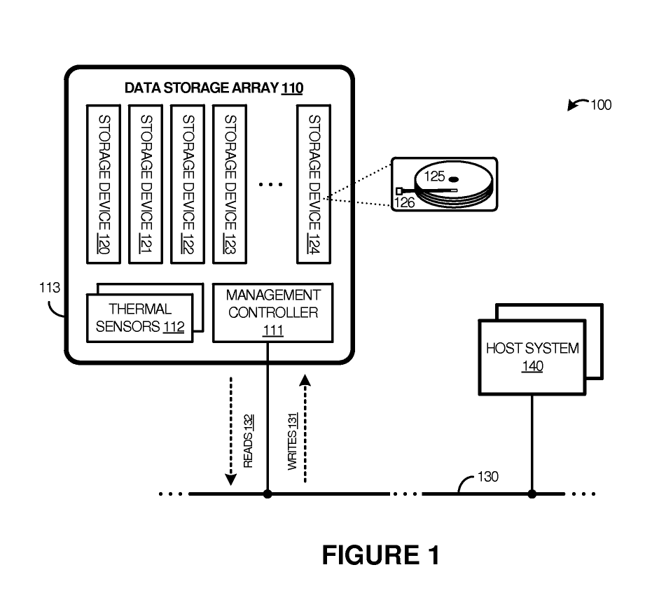

The examples discussed herein employ adjustments to at least seek performance of data storage devices to affect temperatures of enclosures and associated data storage devices. As a first example of a data storage system, FIG. 1 is presented. FIG. 1 is a system diagram illustrating data system 100. System 100 includes data storage array 110 and one or more host systems 140. Data storage array 110 and host system 140 communicate over storage link 130. Data storage array 110 can be included in an environment that includes one or more data storage arrays, such as a rackmount computing environment.

In FIG. 1, data storage array 110 comprises an assembly that includes management controller 111, thermal sensors 112, enclosure 113, and a plurality of data storage devices 120-124. Each of data storage devices 120-124 includes one or more rotating storage media, such as shown in the detailed view for data storage device 124 as including rotating media 125 and read/write heads/armature assembly 126. Management controller 111 is communicatively coupled to data storage devices 120-124 and thermal sensors 112. Although management controller 111 is shown as internal to data storage array 110 in this example, it should be understood that in other examples management controller 111 can be included in other elements external to data storage array 110.

In operation, data storage array 110 receives read or write transactions over storage link 130 issued by host system 140, such as write operations 131 and read operations 132. Responsive to read operations, individual data storage devices in data storage array 110 can retrieve data stored upon associated storage media for transfer to host system 140. Responsive to write operations, individual data storage devices in data storage array 110 stores data on the associated storage media. It should be understood that other components of data storage array 110 and data storage devices 120-124 are omitted for clarity in FIG. 1, such as transaction queues, chassis, fans, interconnect, read/write heads, media, armatures, preamps, transceivers, processors, amplifiers, motors, servos, enclosures, and other electrical and mechanical elements.

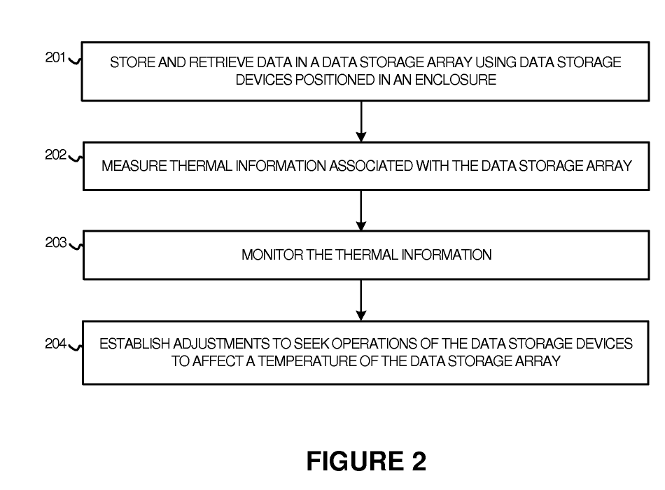

To further illustrate the operation of data system 100, FIG. 2 is provided. FIG. 2 is a flow diagram illustrating a method of operating data storage array 110. The operations of FIG. 2 are referenced below parenthetically. In FIG. 2, data storage array 110 stores and retrieves (201) data in data storage array 110 using data storage devices 120-124 positioned in enclosure 113. Data storage array 110 receives read and write operations over host interface 330 and ones of data storage device 120-124 can handle these operations, such as by storing write data or retrieving read data.

During operation of data storage array 110, management controller 111 measures (202) thermal information associated with data storage array 110. One or more thermal sensors 112 are distributed throughout data storage array 110 in this example. These thermal sensors can measure temperatures or other thermal and heat properties of data storage array 110, and provide thermal information to management controller 111, which monitors (203) the thermal information.

The thermal information associated with data storage array 110 can change over time, such as due to ambient temperature changes outside of enclosure 113, changes in operational workloads of individual data storage devices, or changes in ventilation or climate controls associated with data storage array 110, among other fluctuations. However, the thermal information can indicate one or more temperatures or temperature measurements which exceed desired limits or thresholds for data storage array 110. These thresholds can include thresholds established to prevent data loss, data corruption, or malfunction of data storage devices in data storage array 110. For example, when too high of operating temperatures are encountered in data storage devices, these temperatures can hasten various electrical, mechanical, fluid, or magnetic elements into a degraded operation or malfunction.

Data storage array 110 establishes (204) adjustments to seek operations of the data storage devices to affect a temperature of data storage array 110. Although in some examples, ones of data storage devices 120-124 can be powered down or have associated rotating media spun down to a slower speed or halted operation, these actions may prevent or delay data storage devices 120-124 from handling data storage operations. Management controller 111 instead makes adjustments to seek operations of the data storage devices. These adjustments can be made responsive to a target temperature, such as a temperature level in degrees Celsius, among other temperature scales. Various temperature thresholds can be established as well, with lower temperature thresholds leading to first adjustments in seek operations or other operations of data storage array 110, and higher temperature thresholds leading to second, larger, adjustments in seek operations or more impactful changes in operations of data storage array 110. A series of incremental temperature thresholds can be established which drive incremental adjustments to seek operations or other operations of data storage array 110 depending upon a current temperature level, and whether that temperature level is rising or falling.

As discussed above, seek operations of a data storage device can include associated delays from which a read/write head is moved from an initial position over a storage media to a desired track position. These seek operations might desire for the read/write heads to be moved as quickly as possible. However, this can lead to increased power dissipation in the various electromechanical elements which move or position the read/write heads. Seek operations of the data storage devices in data storage array 110 can be modified to reduce a peak speed of the various electromechanical elements which move or position the read/write heads. This reduction in peak speed can lead to less power dissipation by those elements and thus lower generation of heat by each device and also in the aggregate within enclosure 113.

Various adjustments to seek properties of data storage devices 120-124 can be made. For example, a seek profile can be adjusted for one or more of data storage devices 120-124 which reduces a peak power dissipation over a range of seek operations. For example, shorter seek operations can have less of a reduction in tracking speed than longer seek operations, to provide for a net decrease in power dissipation. In other examples, all seek operations are reduced by a predetermined amount, such as a percentage of speed, time, velocity, acceleration, or power usage to position associated read/write heads.

In further examples, a just-in-time (JIT) seek operation can be established and adjusted for ones of data storage devices 120-124. These JIT seek operations can time the arrival of a read/write head to a desired position over a desired data track the storage media to coincide closely with a desired data block or data sector within that data track. JIT operations can have various levels of adjustment, such as 256 levels in some examples, or a subset thereof. Management controller 311 can make adjustments to the JIT levels or other seek properties based on temperatures measured by any of thermal sensors 112.

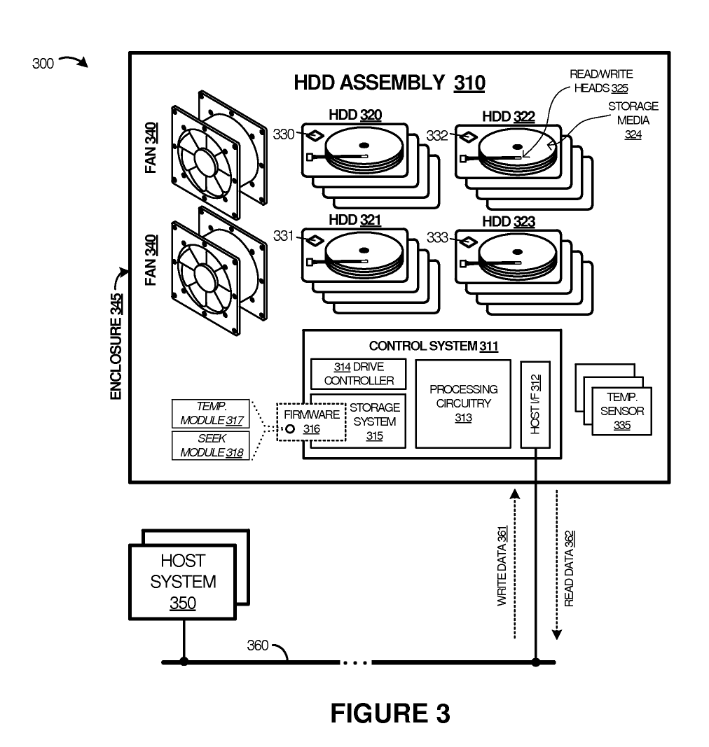

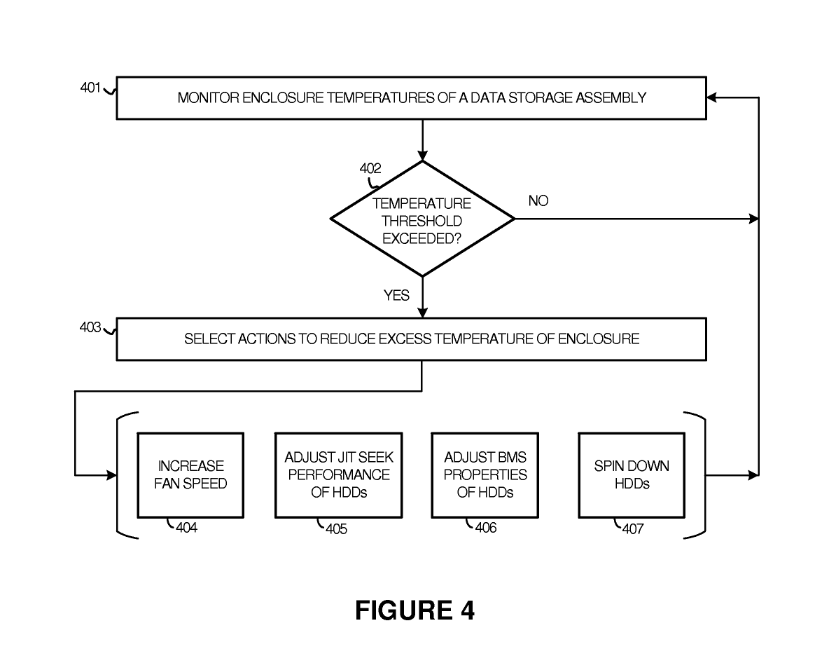

Other properties of data storage array 110 or one of data storage devices 120-124 can be made responsive to a temperature. These further examples are discussed below in FIGS. 3 and 4. For example, fan speed can be adjusted for fans associated with enclosure 111. In other examples, data integrity checks can be altered responsive to temperature, such as reducing or halting background media scans (BMS) or data integrity checks of data storage devices 120-124 during times that a temperature exceeds a threshold level. Furthermore, one or more of data storage devices 120-124 can have associated rotating media spun down or halted in cases where temperatures exceed a second, higher, threshold level. Combinations of these techniques can be employed, and these changes can be applied across only selected ones of data storage devices 120-124 as well as to the entire collection of data storage devices 120-124.

Returning to the elements of FIG. 1, data storage array 110 comprises a plurality of data storage devices 120-124. These data storage devices are coupled to management controller 111 by one or more storage links, which can comprise a serial ATA interface, Serial Attached Small Computer System (SAS) interface, Integrated Drive Electronics (IDE) interface, Non-Volatile Memory Express (NVMe) interface, ATA interface, Peripheral Component Interconnect Express (PCIe) interface, Universal Serial Bus (USB) interface, wireless interface, Direct Media Interface (DMI), Ethernet interface, networking interface, or other communication and data interface, including combinations, variations, and improvements thereof. Data storage array 110 can also comprise cache systems, chassis, enclosures, fans, interconnect, cabling, or other circuitry and equipment.

Management controller 111 includes processing circuitry, communication interfaces, and one or more non-transitory computer-readable storage devices. The processing circuitry can comprise one or more microprocessors and other circuitry that retrieves and executes firmware from memory for operating as discussed herein. The processing circuitry can be implemented within a single processing device but can also be distributed across multiple processing devices or sub-systems that cooperate in executing program instructions. Examples of the processing circuitry include general purpose central processing units, application specific processors, and logic devices, as well as any other type of processing device, combinations, or variations thereof. The communication interfaces can include one or more storage interfaces for communicating with host systems, networks, and the like. The communication systems can include transceivers, interface circuitry, connectors, buffers, microcontrollers, and other interface equipment.

Thermal sensors 112 each comprise one or more sensing elements for measuring temperature and other associated properties of data storage array 110, such as temperatures or other thermal information for data storage devices 120-124 and within enclosure 113. Thermal sensors 112 can comprise thermocouples, thermistors, thermopiles, resistance temperature detectors (RTDs), charge-coupled devices (CCDs), infrared sensors, infrared cameras, or other temperature sensing elements. Thermal sensors 112 can also include various interfaces for communicating measured thermal information, such as to management controller 111. These interfaces can include transceivers, analog-to-digital conversion elements, amplifiers, filters, signal processors, among other elements. In some examples, thermal sensors 112 can each include microcontroller elements to control the operations of thermal sensors 112. In examples where data storage devices 120-124 each include ones of thermal sensors 112, data storage devices can include equipment and circuitry to transfer thermal information over an associated storage or host interface to management controller 111.

Enclosure 113 comprises structural elements to house and structurally support the elements of data storage array 110. Enclosure 113 can include chassis elements, frames, fastening elements, rackmount features, ventilation features, among other elements. In many examples, enclosure 113 also includes fans or other cooling and ventilation elements for providing airflow to the elements of data storage array 110. Enclosure 113 can also include power supply elements to convert external power sources or provide various forms of electrical power to the elements of data storage system 110.

Each of data storage devices 120-124 includes one or more computer readable storage media accessible via one or more read/write heads and associated electromechanical elements. In FIG. 1, an example detailed view of data storage device 124 is shown to highlight rotating media 125 and read/write heads and armature assembly 126, and these elements can be included in each of data storage devices 120-124, although variations are possible among the data storage devices. Data storage devices 120-124 can also each include processing circuitry, communication interfaces, armatures, preamps, transceivers, processors, amplifiers, motors, servos, enclosures, and other electrical and mechanical elements. Data storage devices 120-124 can each comprise a hard disk drive, hybrid disk drive, or other computer readable storage device. Data storage devices 120-124 can each include further elements, such as those discussed for disk drives 320-323 in FIG. 3, although variations are possible. The computer readable storage media of data storage devices 120-124 can each include rotating magnetic storage media, but can additionally include other media, such as solid state drive elements, caches, or cache systems. These other media can include solid state storage media, optical storage media, non-rotating magnetic media, phase change magnetic media, spin-based storage media, or other storage media, including combinations, variations, and improvements thereof. In some examples, data storage devices 120-124 each comprise a hybrid hard drive employing solid state storage elements in addition to rotating magnetic storage media. Associated storage media can employ various magnetic storage schemes, such as random write techniques, shingled magnetic recording (SMR), or perpendicular magnetic recording (PMR), including combinations, variations, and improvements thereof.

Host system 140 can include processing elements, data transfer elements, and user interface elements. In some examples host system 140 is a central processing unit of a computing device or computing system. In other examples, host system 140 also includes memory elements, data storage and transfer elements, controller elements, logic elements, firmware, execution elements, and other processing system components. In yet other examples, host system 140 comprises a RAID controller processor or storage system central processor, such as a microprocessor, microcontroller, Field Programmable Gate Array (FPGA), or other processing and logic device, including combinations thereof. Host system 140 can include, or interface with, user interface elements which can allow a user of data system 100 to control the operations of data system 100 or to monitor the status or operations of data system 100. These user interface elements can include graphical or text displays, indicator lights, network interfaces, web interfaces, software interfaces, user input devices, or other user interface elements. Host system 140 can also include interface circuitry and elements for handling communications over bus 130, such as logic, processing portions, buffers, transceivers, and the like.

Bus 130 can include one or more serial or parallel data links, such as a Peripheral Component Interconnect Express (PCIe) interface, serial ATA interface, Serial Attached Small Computer System (SAS) interface, Integrated Drive Electronics (IDE) interface, ATA interface, Universal Serial Bus (USB) interface, wireless interface, Direct Media Interface (DMI), Ethernet interface, networking interface, or other communication and data interface, including combinations, variations, and improvements thereof. Although one bus 130 is shown in FIG. 1, it should be understood that one or more discrete links can be employed between the elements of data system 100.

As a further example data storage system employing a data storage array, FIG. 3 is presented. FIG. 3 is a system diagram illustrating data storage system 300. Data storage system 300 includes hard disk drive (HDD) assembly 310 and one or more host systems 350. HDD assembly 310 and host system 350 communicate over storage link 360. Various elements of HDD assembly 310 can be included in data storage array 110 of FIG. 1, although variations are possible. Although one HDD assembly 310 is shown in FIG. 3, it should be understood that more than one HDD assembly could be included and linked to host system 350 or other host systems, such as in a data storage environment employing many data storage arrays.

HDD assembly 310 can comprise a storage assembly with associated enclosure and structural elements which is insertable into a rack that can hold other HDD assemblies, such a rackmount server environment. The enclosure can include structural elements to mount the plurality of HDDs and can also include at least one external connector for communicatively coupling control system 311 or host interface 312 of HDD assembly 310 over storage link 360.

HDD assembly 310 can comprise a redundant array of independent disks (RAID) array, or a JBOD device (“Just a Bunch Of Disks”) device which include a plurality of independent disks which can be spanned and presented as one or more logical drives to host system 350. In some examples, HDD assembly 310 comprises a virtual bunch of disks (VBOD) which adds one or more layers of abstraction between physical storage drives and external interfaces. A VBOD can employ various types of magnetic recording technologies and abstract front-end interactions from the particular recording technology. For example, shingled magnetic recording (SMR) hard disk drives typically have inefficiencies for random writes due to the shingled nature of adjacent tracks for data. In SMR examples, the VBOD abstracts the SMR drives and allows random writes and random reads while still having underlying SMR media which ultimately hold the associated data. Other recording techniques can be employed, such parallel magnetic recording (PMR), or Heat-assisted magnetic recording (HAMR), including variations, improvements, and combinations thereof.

Storage link 360 can include one or more links, although a single link is shown in FIG. 3. Storage link 360 can comprise a storage or disk interface, such as Serial Attached ATA (SATA), Serial Attached SCSI (SAS), FibreChannel, Universal Serial Bus (USB), SCSI, InfiniBand, NVMe, Peripheral Component Interconnect Express (PCIe), Ethernet, Internet Protocol (IP), or other parallel or serial storage or peripheral interfaces, including variations and combinations thereof.

Host system 350 can include one or more computing and network systems, such as personal computers, servers, cloud storage systems, packet networks, management systems, or other computer and network systems, including combinations and variations thereof. In operation, host system 350 issues read and write commands or operations to HDD assembly 310 over storage link 360, among other commands or operations which can include control instructions, metadata retrieval operations, configuration instructions, and the like Likewise, HDD assembly 310 can transfer read data over storage link 360, among other information such as graphical user interface information, status information, operational information, drive seek information, temperature information, failure notifications, alerts, and the like.

HDD assembly 310 includes a plurality of hard disk drives (HDDs), namely HDD 320-323, although any number of HDDs can be included. Although FIG. 3 indicates hard disk drives for each of HDD 320-323, in should be understood that HDD 320-323 can each comprise hybrid disk drives which comprise rotating media and solid state storage components which work in tandem. In further examples, optical storage drives are employed, or other computer readable storage device. Each HDD 320-323 is coupled to control system 311 by one or more storage links, which in this example comprises Serial Attached SCSI (SAS) links, although other link types can be employed.

Each HDD 320-323 can comprise similar elements, and for exemplary purposes, a detailed view of HDD 320-323 is shown in FIG. 3 as including rotating storage media 324, read/write heads 325, and associated temperature sensors 330-333, although variations are possible among HDD 320-323. HDD 320-323 can include further elements, such as armatures, preamps, transceivers, processors, amplifiers, motors, servos, cases, seals, enclosures, and other electrical and mechanical elements.

HDD assembly 310 also includes control system 311, one or more temperature sensors 335, one or more ventilation fans 340, and storage enclosure 345. Control system 311 includes processing circuitry 313, drive controller 314, storage system 315, and host interface (I/F) 312. Furthermore, control system 311 includes firmware 316 which includes temperature module 317 and seek module 318 which, when executed by at least processing circuitry 313, operates as described below.

Temperature sensors 335 each comprise one or more sensing elements for measuring temperature and other associated properties of HDD assembly 310, such as temperatures or other thermal information for HDDs 320-323 and within enclosure 345. One or more temperature sensors 335 are distributed throughout HDD assembly 310, such as within enclosure 345, near various ones of the HDDs, near fans 340, or in other locations. Temperature sensors 335 can measure various temperature properties of HDD assembly 310, such as a temperature of enclosure 345, a temperature inside enclosure 345, ambient temperature outside of enclosure 345, and temperatures associated with various components including that of control system 311, fans 340, and HDDs 320-323. Temperature sensors 335 can comprise thermocouples, thermistors, thermopiles, resistance temperature detectors (RTDs), infrared sensing devices, or other temperature sensing elements. Temperature sensors 335 can also include various interfaces for communicating measured thermal information, such as to control system 311. These interfaces can include transceivers, analog-to-digital conversion elements, amplifiers, filters, signal processors, among other elements. In some examples, temperature sensors 335 can each include microcontroller elements to control the operations of temperature sensors 335.

In FIG. 3, each HDD also includes an associated temperature sensor 330-333, which can comprise similar elements as temperature sensors 335. These temperature sensors can be included among the electronic or mechanical elements of each HDD, and can measure temperatures associated with the HDD. More than one temperature sensing element can be included in each HDD to measure various temperature properties of the HDD, such as a temperature of a case or chassis of the HDD, a temperature inside a case of the HDD, media temperature, ambient temperature, and temperatures of various electronic components of the HDD. Each HDD can also include equipment and circuitry to transfer thermal information determined by the associated temperature sensor 330-333 over an associated storage interface to control system 311.

Storage enclosure 345 comprises structural elements to house and structurally support the elements of HDD assembly 310. Enclosure 345 can include chassis elements, frames, fastening elements, rackmount features, ventilation features, among other elements. In many examples, enclosure 345 also includes fans 340 or other cooling and ventilation elements for providing airflow to the elements of HDD assembly 310. Enclosure 345 can also include power supply elements to convert external power sources or provide various forms of electrical power to the elements of HDD assembly 310. Fans 340 can comprise any fan type, such as axial-flow, centrifugal and cross-flow, or other fan types, including associated louvers, fins, or other directional elements, including combinations and variations thereof.

Control system 311 handles storage operations for HDD assembly 310, such as receiving storage operations from host systems over storage link 360 in host interface 312. Write data 331 can be received in one or more write operations, and read data 332 can be provided to hosts responsive to one or more read operations. An interface can be provided to a host system, such as a single (or redundant) Ethernet interface, SATA interface, SAS interface, FibreChannel interface, USB interface, SCSI interface, InfiniBand interface, NVMe interface, PCIe interface, or IP interface, which allows for the host system to access the storage capacity of HDD assembly. Control system 311 can establish any number of logical volumes or logical storage units across the various HDDs in HDD assembly 310, which can comprise spanning, redundant arrays, striping, or other data storage techniques.

Host interface 312 includes one or more storage interfaces for communicating with host systems, networks, and the like over at least link 360. Host interface 312 can comprise transceivers, interface circuitry, connectors, buffers, microcontrollers, and other interface equipment. Host interface 312 can also include one or more I/O queues which receive storage operations over link 360 and buffers these storage operations for handling by processing circuitry 313.

Control system 311 also includes processing circuitry 313, drive controller 314, and storage system 315. Processing circuitry 313 can comprise one or more microprocessors and other circuitry that retrieves and executes firmware 316 from storage system 315. Processing circuitry 313 can be implemented within a single processing device but can also be distributed across multiple processing devices or sub-systems that cooperate in executing program instructions. Examples of processing circuitry 313 include general purpose central processing units, application specific processors, and logic devices, as well as any other type of processing device, combinations, or variations thereof. In some examples, processing circuitry 313 includes a system-on-a-chip device or microprocessor device, such as an Intel Atom processor, MIPS microprocessor, and the like.

Drive controller 314 can include one or more drive control circuits and processors which can control various data redundancy handling among the various HDDs of HDD assembly 310. Drive controller 314 also includes HDD interfaces, such as SAS interfaces to couple to the various HDDs in HDD assembly 310. In some examples, drive controller 314 and processing circuitry 313 communicate over a peripheral component interconnect express (PCIe) interface or other communication interfaces. In some examples, drive controller 314 comprises a RAID controller, RAID processor, or other RAID circuitry. In other examples, drive controller 314 handles management of a particular recording technology, such as SMR or HAMR techniques. As mentioned herein, elements and functions of drive controller 314 can be integrated with processing circuitry 313.

Storage system 315 can comprise any non-transitory computer readable storage media readable by processing circuitry 313 or drive controller 314 and capable of storing firmware 316. Storage system 315 can include volatile and nonvolatile, removable and non-removable media implemented in any method or technology for storage of information, such as computer readable instructions, data structures, program modules, or other data. In addition to storage media, in some implementations storage system 315 can also include communication media over which firmware 316 can be communicated. Storage system 315 can be implemented as a single storage device but can also be implemented across multiple storage devices or sub-systems co-located or distributed relative to each other. Storage system 315 can comprise additional elements, such as a controller, capable of communicating with processing circuitry 313. Examples of storage media of storage system 315 include random access memory, read only memory, magnetic disks, optical disks, flash memory, SSDs, phase change memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media.

Firmware 316, temperature module 317, and seek module 318 can be implemented in program instructions and among other functions can, when executed by control system 311 in general or processing circuitry 313 in particular, direct control system 311 or processing circuitry 313 to operate as described herein. Firmware 316 can include additional processes, programs, or components, such as operating system software, database software, or application software. Firmware 316, temperature module 317, and seek module 318 can also comprise software or some other form of machine-readable processing instructions executable by processing circuitry 313. In at least one implementation, the program instructions can include first program instructions that direct control system 311 to handle read and write operations among the data storage devices, measure and monitor temperature or other thermal information about the elements of HDD assembly 310 (temperature module 317), take action to reduce temperatures in enclosure 345 (seek module 318), such as change fan speeds, altering seek profiles and properties, modifying data integrity check processes, or spinning down HDDs, among other operations.

In general, firmware 316 can, when loaded into processing circuitry 313 and executed, transform processing circuitry 313 overall from a general-purpose computing system into a special-purpose computing system customized to operate as described herein. Encoding firmware 316 on storage system 315 can transform the physical structure of storage system 315. The specific transformation of the physical structure can depend on various factors in different implementations of this description. Examples of such factors can include, but are not limited to the technology used to implement the storage media of storage system 315 and whether the computer-storage media are characterized as primary or secondary storage. For example, if the computer-storage media are implemented as semiconductor-based memory, firmware 316 can transform the physical state of the semiconductor memory when the program is encoded therein. For example, firmware 316 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

To further illustrate the operation of system 300 and HDD assembly 310, FIG. 4 is presented. FIG. 4 is a flow diagram illustrating a method of operation of HDD assembly 310. The operations of FIG. 4 are referenced below parenthetically. The various operations described herein for FIG. 4 can be performed by any combination of elements in HDD assembly 310, such as processing circuitry 313 or drive controller 314 of control system 311, or by elements of HDDs 320-323.

In FIG. 4, HDD assembly 310 receives read and write operations over host interface 312 and link 360. These read and write operations can be issued by host system 350, or other external systems. In write operations, write data is associated with one or more write operations which are received over link 360 from host system 350, such as write data 361 in FIG. 3. Write data can comprise one or more data blocks for storage by HDD assembly 310 which is directed for storage at a designated storage address or storage location among the HDDs of HDD assembly 310. HDD assembly 310 stores the write data for later retrieval, such as read data 362 for delivery to host system 350 over link 360. A particular HDD or set of HDDs can be designated to handle data for a particular logical storage unit (LUN) or storage partition. Read or write operations can be directed to any of the logical partitions, and indicate a storage address, logical unit, partition, or other indication that designates logical blocks in HDD assembly 310 to which read or write operations are directed.

During operation of HDD assembly 310, such as during servicing of read operations or write operations, various temperature sensors monitor (401) enclosure temperatures of HDD assembly 310. In FIG. 3, individual discrete temperature sensors 335 are distributed throughout HDD assembly 310, such as to measure temperatures or other thermal information related to fans 340, structural materials of enclosure 345, ambient temperatures external to enclosure 345, ambient temperature inside of enclosure 345, electronic components of control system 311, or to supplement temperature sensors of HDD 320-323. Likewise, each of HDD 320-323 can include temperature sensors, such as those indicated by temperature sensors 330-335. These temperature sensors 330-335 can measure temperatures or other thermal information related to an associated one of HDD 320-323, such as case temperature of the HDD, storage media temperature, or temperature of circuit boards or electrical components of the HDD. Although the thermal information is discussed herein as comprising temperatures or temperature data, the thermal information can include other information, such as trend information, thermal change rates, rising or falling temperature indicators, or other information.

HDD assembly 310 establishes one or more temperature thresholds, and when a temperature threshold is exceeded (402), HDD assembly 310 selects (403) one or more actions to reduce excess temperature of enclosure 345 to bring the temperature to below the threshold level. These adjustments can be made responsive to a target temperature, such as a temperature level in degrees Celsius, among other temperature scales. Various temperature thresholds can be established, with lower temperature thresholds leading to first adjustments in seek operations or other operations of HDD assembly 310, and higher temperature thresholds leading to second, larger, adjustments in seek operations or more impactful changes in operations of HDD assembly 310. A series of incremental temperature thresholds can be established which drive incremental adjustments to seek operations or other operations of HDD assembly 310 depending upon a current temperature level, and whether that temperature level is rising or falling.

HDD assembly 310 can select actions from among increasing fan speed (404) for fans 340, adjusting JIT seek performance of HDDs (405), adjusting BMS data integrity checking properties of HDDs (406), or spinning down or one or more HDDs (407). These actions can be taken individually or in combination for selected HDDs or for all of the HDDs of HDD assembly 310.

Airflow provided by one or more of fans 340 can be adjusted (404) to change an airflow of enclosure 345. For example, a current fan speed can be monitored along with the current temperature inside enclosure 345, and if a fan speed is not yet at a maximum airflow rate, then the fan or fans can be adjusted to increase an airflow rate by increasing a speed of rotation of one or more of fans 340. In examples where louvered or finned airflow apertures are employed, an openness of louvers or fins can be adjusted to change airflow. Control system 311 can adjust the fan speed, and can receive feedback from fans 340 or from other sensors to indicate a current fan speed (or louver openness in such examples). A first threshold level can be established by control system 311 for using one or more of fans 340 to adjust airflow and temperature in enclosure 345. However, fan speed or louver openness may fail to prevent rise in temperature for any components of HDD assembly 310 above a second temperature threshold.

JIT seek performance can be adjusted (405) to reduce power usage by individual ones of the HDDs of HDD assembly 310. Speed of seek operations can reduced, and a range of speeds can be established over a range of seek distances to establish JIT seek profiles for each HDD. These JIT seek profiles can be adjusted to reduce power usage by HDD 320-323 during seek operations of the associated HDDs. Lower JIT seek levels use less power and generate less heat in a HDD by having a slower seek performance, while higher JIT seek levels use more power and generate more heat in a HDD by having a faster seek performance.

As mentioned above, many discrete JIT seek performance levels can be employed, and JIT seek profiles can be selected from among the various discrete JIT seek performance levels according to a current temperature. More aggressive power reductions using reduced seek performance can be established when the temperatures rise higher, such as each degree in temperature rise above an initial threshold can lead to selecting a different JIT seek performance level to further reduce power usage by HDDs during seek operations. For example, ten different JIT levels can be selected among based on temperature within a ten degree temperature range, with higher temperatures correlated to slower seek performances and lower temperatures correlated to faster seek performance.

To adjust the JIT levels or JIT seek performance of HDD 320-323, control system 311 can first determine a desired JIT seek performance level and responsively transfer instructions over associated storage interfaces to selected ones of HDD 320-323. HDD 320-323 can receive these instructions and implement the instructions to operate according to the received JIT seek performance level or JIT seek performance profile indicated by control system 311.

In addition to adjusting JIT seek performance of HDD 320-323, control system 311 can also alter the operation of various background operations of HDD 320-323, such as background data integrity checks (406). These background data integrity checks, also referred to as Background Media Scan (BMS) operations, are data verification operations performed periodically by HDDs to verify data that has already been written to storage media of the HDDs. These BMS operations ensure that data that resides on the storage media has sufficient data integrity to be read at a later time when a read operation is received. The BMS operations can occur periodically and over the various storage regions of the storage media. Typically, the associated HDD handles BMS operations independent of any external control system.

However, BMS operations can lead to more power dissipation over time by a HDD, and contribute to the rise in temperature of individual HDDs and within enclosure 345. In this example, control system 311 can disable BMS operations for one or more of HDD 320-323. Control system 311 can transfer instructions over a storage interface of an associated HDD to instruct that HDD to disable or enable the BMS operations for that HDD.

Adjusting airflow, fan speed, JIT seek performance, BMS operations, or other properties of HDD 320-323 or data assembly 310 can lead to lower temperatures within enclosure 345, and thus a better operating environment for the individual HDDs and associated electronics. However, thermal conditions might exist which do not respond well to these adjustments and actions, such as when external ambient temperature rises above a threshold temperature level. The external ambient temperature might rise due to temperatures outside of enclosure 345 rising, such as in a hot data center, due to power outages or air conditioning failures of the building in which enclosure 345 resides, due to blockages of venting or apertures of enclosure 345, or due to other factors. In these cases, further actions can be taken by control system 311, such as responsive to a maximum threshold temperature level.

One or more of HDD 320-323 can be powered down. Alternatively, one or more of HDD 320-323 can have associated storage media halted, such as by halting a rotation or spin of rotating storage media, referred to as being spun down (407). This can further reduce power consumption of the associated HDD at the expense of preventing data access to the associated storage media. However, in certain maximum temperature events, data integrity of the storage media can be threatened and a powered down or spun down mode of operation is desired to preserve the data or to prevent electrical/mechanical elements from degrading.

The various actions taken by control system 311 to control the temperature within enclosure 345 or the temperature experienced by various components within enclosure 345 can be performed across all of HDD 320-323 or for individually selected ones of HDD 320-323. For example, if the ambient temperature inside of enclosure 345 rises above a threshold, then JIT seek profiles of all HDDs in enclosure 345 can be adjusted to reduce the temperature inside enclosure 345. In other examples, control system 311 can identify a particular one or ones among HDD 320-323 that are experiencing elevated temperatures, and apply one or more of the actions to those particular HDDs to reduce the temperature inside enclosure 345. In yet further examples, the temperature of a particular HDD can indicate failure of that particular HDD, and control system 311 can isolate that HDD by powering that HDD down or indicating the failure to an operator.

Control system 311 continues to monitor the operation and temperatures to identify when a desired temperature has fallen below a threshold level, such as when the adjustments or actions have succeeded in bringing down the temperature in enclosure 345. Threshold levels can be established for returning performance levels to previous levels or to increasing seek performance of various HDDs once temperatures fall below the threshold levels. Additionally, fan speed, power, or spin properties of the HDD can be adjusted responsive to falling temperatures. Thus, control system 311 can maintain temperatures within enclosure 345 to within a predetermined range or to be below a threshold temperature, with seek performance degraded using the above actions and adjustments to bring temperature down and seek performance enhanced when temperatures fall below certain temperatures. Advantageously, enhanced operation of a data storage assembly or data storage array can be established which allows for continued operation of data storage devices during times of elevated temperatures. Also, performance and properties of the data storage drives themselves can be altered and adjusted to control temperatures within a data storage enclosure.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A data storage array, comprising:
a plurality of data storage devices positioned in an enclosure, each of the plurality of data storage devices comprising rotating media for storage and retrieval of data;
one or more temperature sensors configured to measure thermal information associated with the data storage array; and
a management controller configured to monitor the thermal information and establish adjustments to at least seek operations of the plurality of data storage devices to control a temperature in the enclosure.

2. The data storage array of claim 1, comprising:
when the temperature in the enclosure exceeds a threshold temperature, the management controller configured to reduce seek performance of the plurality of data storage devices to reduce the temperature in the enclosure to below the threshold temperature.

3. The data storage array of claim 1, comprising:
when the temperature in the enclosure exceeds a first threshold temperature, the management controller configured to reduce seek performance of the plurality of data storage devices to reduce the temperature in the enclosure to below the first threshold temperature; and
when the temperature in the enclosure exceeds a second threshold temperature higher than the first threshold temperature, the management controller configured to selectively halt rotation of associated rotating media of ones of the plurality of data storage devices until at least the temperature in the enclosure falls below the second threshold temperature.

4. The data storage array of claim 1, wherein the adjustments to the seek operations comprise adjustments to just-in-time (JIT) seek performance of the plurality of data storage devices.

5. The data storage array of claim 4, comprising:
the management controller configured to establish reduced JIT seek performance for the plurality of data storage devices to bring the temperature in the enclosure below a threshold temperature.

6. The data storage array of claim 1, comprising:
when the temperature in the enclosure exceeds a threshold temperature, the management controller configured to identify one or more of the plurality of data storage devices that exceed a thermal threshold, and responsively alter seek performance for the one or more of the plurality of data storage devices to reduce the temperature in the enclosure.

7. The data storage array of claim 6, comprising:
when the temperature in the enclosure continues to exceed the threshold temperature after the management controller alters the seek performance for the one or more of the plurality of data storage devices, the management controller configured to alter the seek performance for further ones of the plurality of data storage devices to reduce the temperature in the enclosure.

8. The data storage array of claim 1, comprising:
the management controller configured to monitor the thermal information and make adjustments to at least one of a plurality of operational factors of the data storage array to reduce the temperature in the enclosure to below a temperature threshold, the operational factors comprising fan speed of at least one fan ventilating the enclosure, a just-in-time (JIT) seek performance of the plurality of data storage devices, and background media scan (BMS) integrity checking of the plurality of data storage devices.

9. The data storage array of claim 8, comprising:
when the temperature in the enclosure fails to fall below the temperature threshold after the management controller makes a predetermined quantity of adjustments to the operational factors, the management controller configured to instruct ones of the plurality of data storage devices to halt rotation of associated rotating media.

10. A method of operating a data storage array that includes a plurality of data storage devices positioned in an enclosure, each of the plurality of data storage devices comprising rotating media for storage and retrieval of data, the method comprising:
measuring thermal information associated with the data storage array using one or more thermal sensors to identify at least a temperature in the enclosure;
determining adjustments to at least seek operations of the plurality of data storage devices to affect the temperature in the enclosure; and
transferring instructions to one or more of the plurality of data storage devices to implement the adjustments to the seek operations.

11. The method of claim 10, further comprising:
when the temperature in the enclosure exceeds a threshold temperature, reducing seek performance of the plurality of data storage devices to reduce the temperature in the enclosure to below the threshold temperature.

12. The method of claim 10, further comprising:
when the temperature in the enclosure exceeds a first threshold temperature, reducing seek performance of the plurality of data storage devices to reduce the temperature in the enclosure to below the first threshold temperature; and
when the temperature in the enclosure exceeds a second threshold temperature higher than the first threshold temperature, selectively halting rotation of associated rotating media of ones of the plurality of data storage devices until at least the temperature in the enclosure falls below the second threshold temperature.

13. The method of claim 10, wherein the adjustments to the seek operations comprise adjustments to just-in-time (JIT) seek performance of the plurality of data storage devices.

14. The method of claim 13, further comprising:
establishing reduced JIT seek performance for the plurality of data storage devices to bring the temperature in the enclosure below a threshold temperature.

15. The method of claim 10, further comprising:
when the temperature in the enclosure exceeds a threshold temperature, identifying one or more of the plurality of data storage devices that exceed a thermal threshold, and responsively altering seek performance for the one or more of the plurality of data storage devices to reduce the temperature in the enclosure.

16. The method of claim 15, further comprising:
when the temperature in the enclosure continues to exceed the threshold temperature after altering the seek performance for the one or more of the plurality of data storage devices, altering the seek performance for further ones of the plurality of data storage devices to reduce the temperature in the enclosure.

17. The method of claim 10, further comprising:
monitoring the thermal information and make adjustments to at least one of a plurality of operational factors of the data storage array to reduce the temperature in the enclosure to below a temperature threshold, the operational factors comprising fan speed of at least one fan ventilating the enclosure, a just-in-time (JIT) seek performance of the plurality of data storage devices, and background media scan (BMS) integrity checking of the plurality of data storage devices.

18. The method of claim 17, further comprising:
when the temperature in the enclosure fails to fall below the temperature threshold after the management controller makes a predetermined quantity of adjustments to the operational factors, instructing ones of the plurality of data storage devices to halt rotation of associated storage media.

19. A data storage assembly, comprising:
a plurality of data storage devices comprising rotating magnetic media for storage and retrieval of data and at least one temperature sensor;
an enclosure configured to enclose and structurally support the plurality of data storage devices, the enclosure comprising one or more temperature sensors configured to measure temperature in the enclosure and one or more fans configured to provide airflow to the plurality of data storage devices in the enclosure;
a control system configured to monitor the temperature in the enclosure using the one or more temperature sensors and temperature information received from the plurality of data storage devices;
the control system configured to adjust at least one of a plurality of operational factors of the data storage assembly to maintain the temperature in the enclosure below a temperature threshold, the operational factors comprising fan speed of the one or more fans, a just-in-time (JIT) seek performance of the plurality of data storage devices, and background media scan (BMS) integrity checking of the plurality of data storage devices.

20. The data storage assembly of claim 19, comprising:
when the temperature in the enclosure fails to fall below the temperature threshold after the control system makes a predetermined quantity of adjustments to the operational factors, the control system configured to instruct ones of the plurality of data storage devices to halt rotation of associated rotating magnetic media.
